(19) United States
(12) Patent Application Publication
(10) Pub. No.: US 2002/0047314 A1
(43) Pub. Date: Apr. 25, 2002

(54) LINEAR MOTOR WITH COIL ASSEMBLIES MOLDED IN SYNTHETIC RESIN

(76) Inventor: SEIKI TAKEDOMI, HIKI-GUN (JP)

Correspondence Address: MCCORMICK PAULDING AND HUBER, CITY PLACE II, 185 ASYLUM STREET, HARTFORD, CT, 061034102

(21) Appl. No.: 09/170,157

(22) Filed: Oct. 13, 1998

(30) Foreign Application Priority Data
Oct. 14, 1997 (JP) 9-280795

(51) Int. Cl. H02K 41/00

(52) U.S. Cl. 310/12

(57) ABSTRACT

There is provided a moving magnet type linear motor having a reduced magnetic gap and an improved motive force and adapted to down-sizing, wherein it comprises a stator B including a plurality of sequentially arranged coil assemblies 3 having coils 11 formed by winding self-fusion-adhesive conductive wires, a plurality of permanent magnets 2 arranged to show opposite polarities vis-à-vis with a magnetic gap G interposed therebetween and a moving element A including a yoke 1 rigidly fitted to said permanent magnets 2 and forming a magnetic circuit with said permanent magnets 2, said moving element A being movable along the direction of arrangement of said coil assemblies 3 contained in said magnetic gap G. Said stator B includes an upper coil frame 5 and a lower coil frame 6 for rigidly holding said coil assemblies 3 in such a way that the surfaces of said coil assemblies 3 are flush with each other.

### BACKGROUND OF THE INVENTION

1. Field of the Invention

This invention relates to a so-called moving magnet type linear motor comprising a coil arranged at the stator side and a permanent magnet at the moving element side and, more particularly, it relates to a linear motor of the above identified type having its motive power enhanced by reducing the magnetic gap on the moving element side.

2. Related Art Statement

Linear motors have been popularly used as linear drive devices such as head drive units of magnetic disc drives and X-Y plotters because they are relatively light weight and can be manufactured at relative low cost.

Linear motors are classified into two categories: the moving magnet type having a permanent magnet arranged on the moving element side and the moving coil type having a coil arranged on the moving element side. FIG. 6 of the accompanying drawings schematically illustrates a known linear motor of the moving magnet type. The present invention provides a linear motor of this type.

Referring to FIG. 6, the illustrated linear motor of the moving magnet type comprises a number of flat coils 53 (53a, 53b) arranged (in the magnetic gap G) between a pair of permanent magnets 52 (52a, 52b) fitted to a yoke 51 so that the yoke 51 operates as moving element A while the flat coil 53 operates as stator B of the linear motor. The yoke 51 is made of a ferromagnetic material such as steel and has a U-shaped cross section and a pair of permanent magnets 52 are securely fitted to the opposite inner surfaces of the yoke 51. The permanent magnets 52 are magnetized transversally such that their oppositely disposed surfaces show opposite magnetic polarities and they form a magnetic circuit with the yoke 51. The moving element A is arranged such that the stator B is located within its magnetic gap G and it is movable along the flat coils 53 (in the direction perpendicular relative to FIG. 6.

The stator B comprises a plurality of flat coils 53 arranged in the direction perpendicular relative to FIG. 6. If the flat coils 53 shows variances in the flatness, a rippling phenomenon can appear in the motive force of the linear motor. Therefore, the flat coils 53 of the known linear motor of FIG. 6 are bonded to the coil base 54 typically by means of adhesive to make the surfaces of the flat coils 53 show a single plane on either side. In a linear motor having the above described configuration, the flat coils 53 are magnetically excited with appropriately shifted phases so that the moving element A is subjected to a motive force in the direction of arrangement of the coils according to the Fleming's left hand rule and is forced to move linearly. If a functional member is arranged on the moving element A, it will move linearly to function in an intended fashion.

With a linear motor of the type under consideration, the motive force increases as the magnetic gap G decreases. More specifically, as the magnetic gap G is reduced, the leakage of magnetic flux among the magnets is also reduced to increase the magnetic flux density and hence the motive force of the linear motor. If the motive force is given, on the other hand, the cross sectional area of the linear motor can be reduced to reduce the rate of power consumption or that of heat generation of the linear motor.

However, with the known linear motor shown in FIG. 6, the magnetic gap G is increased by the thickness of the coil base 54 to reduce the motive force of the linear motor proportionally because the flat coils 53 are securely fitted to the coil base 54 before they are arranged in position in the magnetic gap G. Additionally, the use of a coil base 54 itself baffles the efforts for down-sizing the linear motor. These and other problems have to be dissolved before realizing an improved linear motor.

Japanese Patent Application Laid-Open No. 7-177722 proposes a linear motor comprising multiple-phase coils formed integrally by using a resin material. However, the linear motor disclosed in the application is of the moving coil type and hence not applicable to linear motors of the moving magnet type. In the case of a linear motor of the moving magnet type, the stator is longer than the moving element and formed by sequentially arranging a number of coils and, therefore, a very large metal mold will be required to produce them integrally by molding, using a resin material. The use of such a large metal mold will be costly and the operation of producing coils integrally by using such a large metal mold and a resin material will not be realistic.

In the case of a linear motor as shown in FIG. 6, the flat coils 53 are bonded to the coil base 54 by means of adhesive, involving cumbersome operations and requiring a long time and a considerable number of processing steps to consequently raise the overall cost of producing such a linear motor.

In view of the above identified problems and other problems of known linear motors of the type under consideration, it is therefore the object of the present invention to provide a moving magnet type linear motor having a reduced magnetic gap and an improved motive force and adapted to down-sizing.

### SUMMARY OF THE INVENTION

According to the invention, the above object and other objects of the invention are achieved by providing a linear motor comprising a stator including a plurality of sequentially arranged coil assemblies having coils formed by winding self-fusion-adhesive conductive wires, a plurality of permanent magnets arranged to show opposite polarities vis-à-vis with a magnetic gap interposed therebetween and a moving element including a yoke rigidly fitted to said permanent magnets and forming a magnetic circuit with said permanent magnets, said moving element being movable along the direction of arrangement of said coil assemblies contained in said magnetic gap, characterized in that said stator includes coil support members for rigidly holding said coil assemblies in such a way that the surfaces of said coil assemblies are flush with each other. A linear motor according to the invention and having such an arrangement can eliminate the use of a coil base to reduce the magnetic gap than ever.

Preferably, said coil assemblies are collectively molded by insertion molding of said coils, using synthetic resin. Alternatively, said coil assemblies are molded by insertion molding of said coils, using synthetic resin, on a phase by phase basis.

Still preferably, a cooling agent flow path is formed in each of said coil support members to allow a cooling agent to flow through the cooling agent flow path and cool the coils.

Further, said coil support members comprise an upper flame for holding the upper part of said coil assemblies and a lower flame for holding the lower part thereof.

Furthermore, each of said upper and lower flames has a cooling agent flow path through which a cooling agent flows.

In addition, each of said upper and lower flames has a groove for receiving the upper and lower ends of said coil assemblies. Also, said upper and lower flames can be made of aluminum.

The above-described and other objects, and novel feature of the present invention will become apparent more fully from the description of the following specification in conjunction with the accompanying drawings.

### BRIEF DESCRIPTION OF THE DRAWINGS

FIG. 1 is a schematic cross sectional lateral view of a preferred embodiment of linear motor according to the invention.

FIG. 2 is a schematic front view and a schematic side view of the stator of the embodiment of linear motor of FIG. 1.

FIG. 3 is a schematic perspective view of the coil assemblies of the embodiment of linear motor of FIG. 1.

FIG. 4 is a schematic cross sectional view of the coil assemblies of FIG. 3 taken along line A-A in FIG. 3.

FIG. 5 is an enlarged schematic partial view of the coil assemblies of FIG. 3 showing the portion surrounded by circle B in FIG. 4.

FIG. 6 is a schematic cross sectional lateral view of a known linear motor of the type under consideration.

### DESCRIPTION OF THE PREFERRED EMBODIMENT

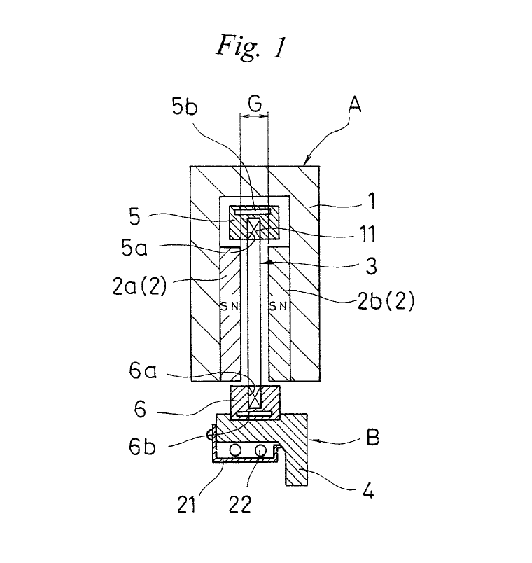

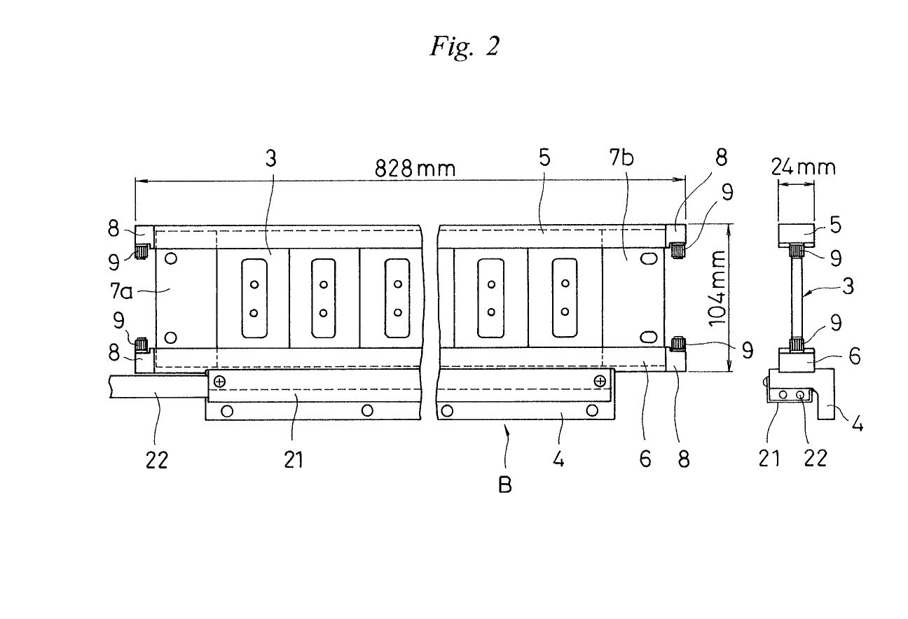

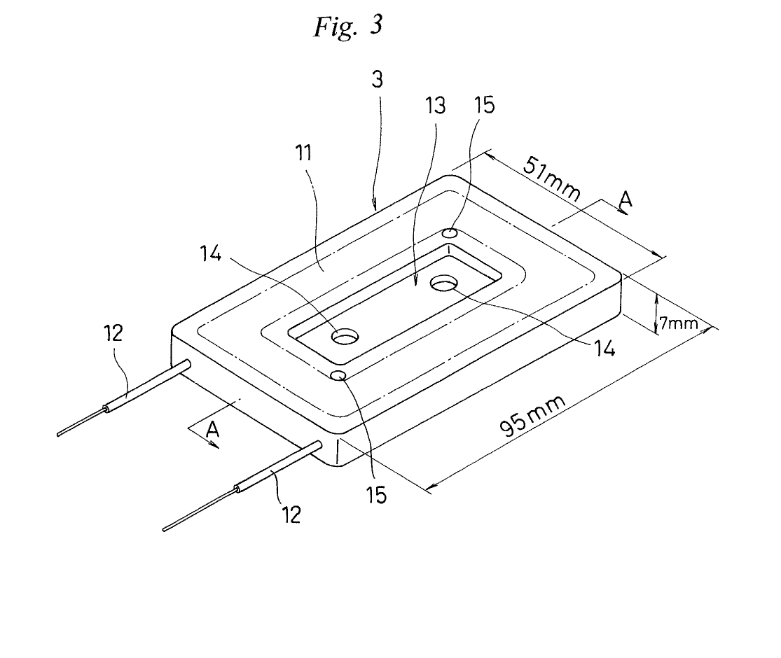

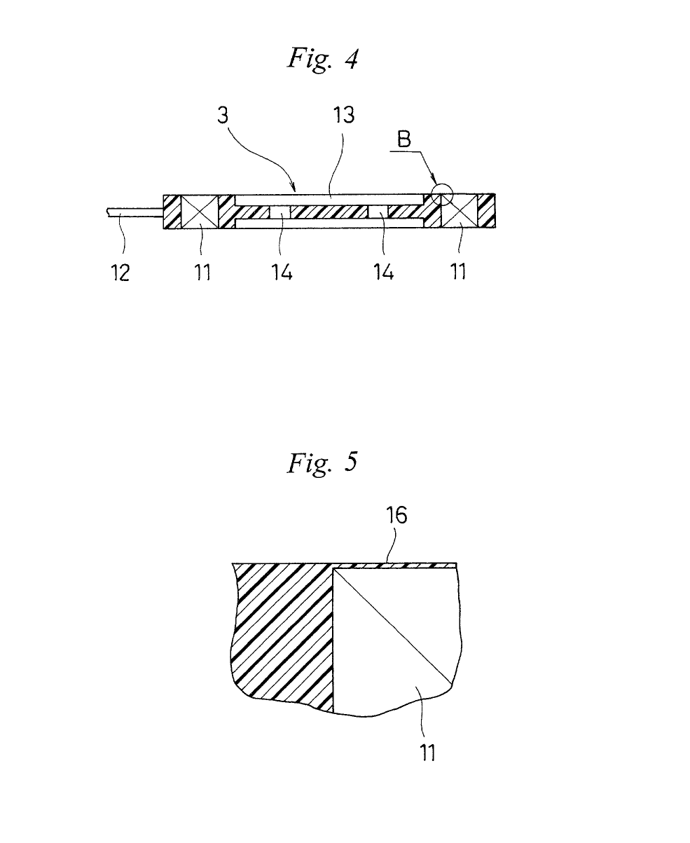

Now, the present invention will be described in greater detail by referring to the accompanying drawings that illustrate a preferred embodiment of the invention. FIG. 1 is a schematic cross sectional lateral view of a preferred embodiment of linear motor according to the invention. FIG. 2 is a schematic front view and a schematic side view of the stator of the embodiment of linear motor of FIG. 1. FIG. 3 is a schematic perspective view of the coil assemblies of the embodiment of linear motor of FIG. 1. FIG. 4 is a schematic cross sectional view of the coil assemblies of FIG. 3 taken along line A-A in FIG. 3. FIG. 5 is an enlarged schematic partial view of the coil assemblies of FIG. 3 showing the portion surrounded by circle B in FIG. 4.

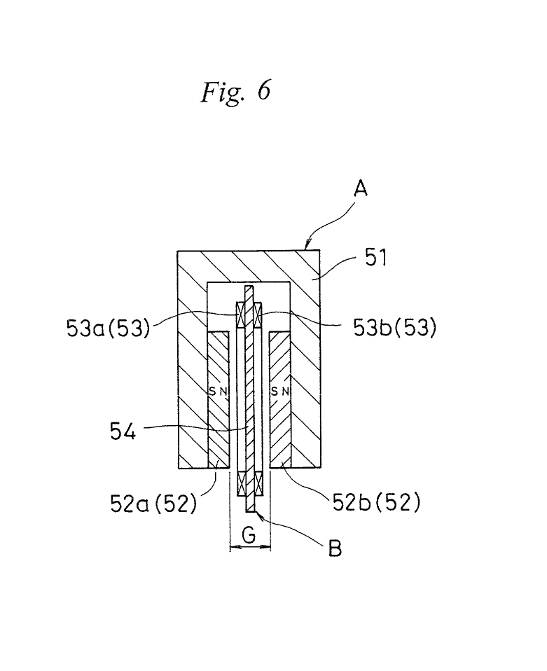

A linear motor according to the invention is a so-called moving magnet type linear motor and comprises a yoke 1, permanent magnets 2 (2a, 2b) fitted to the yoke 1 and coils 11 arranged between the permanent magnets 2 (2a, 2b) (and in the magnetic gap G) . The yoke side operates as moving element A, whereas the coil side operates as stator B, the moving element A being movable in the direction of arrangement of the coils and, in this sense, this linear motor falls in the known category of linear motor as described above by referring to FIG. 6.

A linear motor according to the invention includes an upper and a lower flames (coil support members) 5, 6 which support a plural of coil assemblies 3 having coils 11. The linear motor has a reduced magnetic gap G that is realized by eliminating the use of a coil base to allow it to show an increased motive force, reduced dimensions and an improved heat emitting efficiency.

Referring to the embodiment of FIG. 1, the yoke 1 is made of a ferromagnetic material such as steel and has a U-shaped cross section and a pair of permanent magnets 2a, 2b are securely fitted to the opposite inner surfaces of the yoke 1 with a magnet gap interposed therebetween. The permanent magnets 2a, 2b are magnetized transversally such that their oppositely disposed surfaces show opposite magnetic polarities and they form a magnetic circuit with the yoke 1. A magnetic gap G is produced between the permanent magnets 2a, 2b. Note that the a functional member (not shown) is fitted to the yoke 1 in such a way that it may be linearly moved along the stator B by means of a guide (not shown).

On the other hand, the stator B is realized by a plurality of the coil assemblies 3 sequentially arranged on a base 4. Unlike the known linear motor of FIG. 6, the coil assemblies 3 of the stator side B of this embodiment are held in position by the upper frame 5 and the lower frame 6 and rigidly fitted to the base 4. Thus, the coils 11 are arranged within the magnetic gap G in such a way that the surfaces of the coils are flush with each other without using any coil base. Therefore, the magnetic gap G can be reduced relative to that of any known linear motor because of the non-existence of a coil base. Additionally, since a plurality of identical coil assemblies 3 are arranged in this embodiment, there is no need of using a large metal mold for producing coils of the stator side B.

The upper frame 5 and the lower frame 6 are drawn aluminum members and have respective coil insertion/engagement grooves 5a, 6a running longitudinally all the way along their total length. The upper and lower ends of the coil assemblies 3 are received respectively in the grooves 5a, 6a. Thus, the coil assemblies 3 are rigidly secured by the upper and lower frames 5 and 6.

A pair of end plates 7a, 7b are also received in the grooves 5a, 6b at the opposite ends thereof. Thus, the upper frame 5 is located above the lower frame 6 as they are supported by the end plates 7a, 7b at the opposite ends. Additionally, both the frames 5, 6 are provided at the opposite ends thereof with respective terminal metal fittings 8 that prevents the end plates 7a, 7b from being released unintentionally. Thus, the coil assemblies 3 are sequentially arranged between the end plates 7a, 7b as they are received in the grooves 5a, 6a.

Thus, in the embodiment of linear motor according to the invention, the coil assemblies 3 are rigidly secured by the upper and lower frames 5, 6 and their surfaces are made flush with each other to ensure the coils of the stator side B a sufficient degree of strength and surface flatness without using any coil base.

As shown in FIG. 3, each of the coil assemblies 3 of the embodiment of linear motor according to the invention is realized by insertion molding of its coil 11, using synthetic resin. The coil 11 is formed by winding a self-fusion-adhesive conductive wire of a diameter of φ 0.45 mm by about 300 turns and then heating it until the coat is fused and adjacent windings adhere each other, maintaining the electrically insulated condition, to produce an independent coil 11. Each of the coil assemblies 3 in FIG. 3 is formed by insertion molding of its coil, using glass reinforced epoxy resin.

Referring to FIG. 3, the coil 11 of each of the coil assemblies 3 is buried in a manner as indicated by broken lines and the lead wires 12 of the coil 11 is drawn out from a narrow end of the coil assembly 3. The lead wires 12 are the connected to a power supply cable 22 in a cable cover 21 that is secured to the base 4 shown in FIG. 2. On the other hand, as shown in FIGS. 4 and 5, the coil 11 is buried in an about 0.1 mm thick resin layer 16 under a coated condition. The coil assembly 3 is additionally provided with a pair of holes 15 to evidence the use of a pair of alignment pins at the time of insertion molding of the coil 11.

Still additionally, the coil assembly 3 has a central recess 13 and a pair of alignment holes 14 at the bottom of the recess 13. While the alignment holes 14 may be used when the coil assemblies 3 are sequentially arranged and connected to each other to produce a stator B, they are not necessary for this embodiment because the coil assemblies 3 are secured in position by the upper frame 5 and the lower frame 6 in this embodiment of linear motor.

The upper frame 5 and the lower frame 6 of the stator B are provided with respective cooling water flow paths (cooling agent flow paths) 5b, 6b. Cooling water is fed to the paths 5b, 6b by way of respective nipples 9 arranged on the terminal metal fittings 8. Since the coils 11 are securely held in position by the upper frame 5 and the lower frame 6 made of thermally highly conductive aluminum, the heat generated in the coils 11 can easily be transmitted to the upper frame 5 and the lower frame 6. Thus, the heat generated in the coils 11 is transmitted to the upper frame 5 and the lower frame 6 and then quickly moved away by the cooling water flowing through the paths 5b, 6b. Therefore, any heat generated in the coils 11 can be removed efficiently and effectively and, additionally due to the fact that the coils 11 are subjected to insertion molding, using synthetic resin, the heat is prevented from being emitted into the atmosphere. As a result, the permanent magnets 2 are protected against harmful effects of heat that can significantly reduce their magnetic force and the guide of the moving element can be prevented from undesiredly becoming distorted and deformed.

Thus, in a linear motor according to the invention and having a configuration as described above, the coils 11 are magnetically excited with appropriately shifted phases so that the moving element A is subjected to a motive force in the direction of arrangement of the coils according to the Fleming's left hand rule and is forced to move linearly as in the case of known linear motors of the type under consideration. It may be appreciated that, for example, three coils 11 may be made to show a same phase so that every third coil 11 is magnetically excited with an appropriately shifted phase in the row of the coils 11. Alternatively, a magnetic scale may be arranged on the stator B to operate as encoder with a sensor arranged on the moving element A in order to correctly position the moving element relative to the stator.

As described above, the invention made by the present inventor has been described in detail based on the embodiments. The present invention, however, is not limited to the above-described embodiments, and can be varied in may ways within the scope of the invention.

For example, a number of coil assemblies 3 realized by insertion molding of respective coils 11 are held between an upper frame 5 and a lower frame 6 in the above embodiment, it may be so arranged that self-fusion-adhesive coils 11 are directly held by an upper frame 5 and a lower frame 6 (without using molded resin). In short, coil assemblies as used herein may comprise only respective coils.

While each of the coil assemblies of the above described embodiment is realized by insertion molding of a single coil 11 in the above described embodiment, a coil assembly 3 may be formed by insertion molding of a plurality of coils 11. In this case, it maybe appreciated that coils 11 molded in the same coil assembly 3 show a same and identical phase.

While cooling water is made to flow through the upper frame 5 and the lower frame 6 of the above described embodiment, the heat generated by the coils 11 may be removed without using cooling water. As described, the heat generated by the coils 11 can be easily conducted to the upper and lower frames and emitted externally due to the structural feature of the embodiment of linear motor so that heat can be satisfactorily removed from the embodiment without using cooling water.

Note that the numerical values cited in the above description of the preferred embodiment represent only examples and the present invention is by no means limited by those numerical values.

Finally, while the present invention is described above in terms of a longitudinal moving magnet type linear motor, it may be applied to transversal moving magnet type linear motors.

The advantages of the present invention will be summarily described below.

Since the coil assemblies are securely held in position by an upper frame and a lower frame, the use of a coil base is eliminated so that the magnetic gap can be reduced than ever. Thus, a linear motor according to the invention can provide more motive force and reduce its dimensions.

Further, since insertion molding is used to hold the coils, the heat generated by the coils can be effectively prevented from being directly emitted into the atmosphere. Additionally, since identical coil assemblies are sequentially arranged in a linear motor according to the invention, no large metal mold is required for insertion molding so that the overall manufacturing cost can be significantly reduced.

Furthermore, since the heat generated by the coils is removed by way of the frames, the coil cooling effect can be improved by flowing cooling water through the upper and lower frames.

What is claimed is:

1. A linear motor comprising:
a stator including a plurality of sequentially arranged coil assemblies having coils formed by winding self-fusion-adhesive conductive wires,
a plurality of permanent magnets arranged to show opposite polarities vis-à-vis with a magnetic gap interposed therebetween, and
a moving element including a yoke rigidly fitted to said permanent magnets and forming a magnetic circuit with said permanent magnets, said moving element being movable along the direction of arrangement of said coil assemblies contained in said magnetic gap, wherein,
said stator includes coil support members for rigidly holding said coil assemblies in such a way that the surfaces of said coil assemblies are flush with each other.

2. A linear motor according to claim 1, wherein said coil assemblies are molded by insertion molding of said coils, using synthetic resin.

3. A linear motor according to claim 1, wherein said coil assemblies are molded by insertion molding of said coils, using synthetic resin, on a phase by phase basis.

4. A linear motor according to claim 1, wherein a cooling agent flow path is formed in each of said coil support members to allow a cooling agent to flow through the cooling agent flow path and cool said coils.

5. A linear motor according to claim 1, wherein said coil support members comprises an upper flame for holding the upper part of said coil assemblies and a lower flame for holding the lower part thereof.

6. A linear motor according to claim 5, wherein each of said upper and lower flames has a cooling agent flow path through which a cooling agent flows.

7. A linear motor according to claim 5, wherein each of said upper and lower flames has a groove for receiving the upper and lower ends of said coil assemblies.

8. A linear motor according to claim 5, wherein said upper and lower flames are made of aluminum.
